(19) United States
(12) Patent Application Publication
(10) Pub. No.: US 2012/0127521 A1
(43) Pub. Date: May 24, 2012

(54) IMAGE FORMING APPARATUS, IMAGE FORMING SYSTEM, AND IMAGE FORMING METHOD IN WHICH IMAGE IS FORMED WITH APPROVAL OF MANAGEMENT USER

(75) Inventor: Shuji Murata, Osaka (JP)

(73) Assignee: KYOCERA MITA CORPORATION, Osaka (JP)

(21) Appl. No.: 13/297,801

(22) Filed: Nov. 16, 2011

(30) Foreign Application Priority Data
Nov. 19, 2010 (JP) 2010-259421

(51) Int. Cl. G06F 3/12

(52) U.S. Cl. 358/1.15

(57) ABSTRACT

An image forming apparatus forms an image with approval of a management user and includes a presence checking unit, a job receiving unit, and an approval requesting unit. The presence checking unit determines whether or not the management user is present at a predetermined terminal apparatus. The job receiving unit, upon receipt of a job request from a user, determines whether or not approval of the management user for job execution is necessary and, if it is determined that the approval needs to be obtained, executes a job based on the job request after obtaining the approval. The approval requesting unit, if it is determined by the job receiving unit that the approval needs to be obtained, selects the management user who is present based on a checking result obtained by the presence checking unit, and transmits an approval request to the selected management user.

### INCORPORATION BY REFERENCE

This application is based upon and claims the benefit of priority from the corresponding Japanese Patent application No. 2010-259421, filed Nov. 19, 2010, the entire contents of which is incorporated herein by reference.

### BACKGROUND

The present invention relates to image forming apparatuses, systems, and methods in which images are formed with approval of a management user.

Image forming apparatuses, such as multifunctional apparatuses, are known in which printing using document data stored in the image forming apparatuses which has predetermined management information attached thereto is only allowed after user authentication or checking by a user.

In the above-described technique, approval is immediately given when a user who made the print request with respect to a document, is a management user (a user having authority to print the document using the document data) who manages the document data, but the approval is not immediately given when the user is not a management user and a management user is not present.

### SUMMARY

An image forming apparatus according to an embodiment of the present disclosure is an image forming apparatus that forms an image with approval of a management user, and includes: a presence checking unit, a job receiving unit, and an approval requesting unit. The presence checking unit determines whether or not the management user is present at a predetermined terminal apparatus. The job receiving unit, upon receipt of a job request from a user, determines whether or not approval of a management user for job execution needs to be obtained and, if it is determined that approval needs to be obtained, executes a job based on the job request after obtaining the approval. The approval requesting unit, if it is determined by the job receiving unit that approval needs to be obtained, selects the management user who is present based on a checking result obtained by the presence checking unit, and transmits an approval request to the selected management user.

An image forming system according to another embodiment of the present disclosure is an image forming system that forms an image with approval of a management user, and includes: an image forming apparatus and a plurality of terminal apparatuses used by a predetermined plurality of management users. The image forming apparatus includes: a presence checking unit, a job receiving unit, and an approval requesting unit. The presence checking unit determines whether or not the plurality of management users are present at the terminal apparatuses. The job receiving unit, upon receipt of a job request from a user, determines whether or not approval of one of the plurality of the management users needs to be obtained for job execution and, if it is determined that approval needs to be obtained, executes a job based on the job request after obtaining the approval. The approval requesting unit, if it is determined by the job receiving unit that the approval needs to be obtained, selects the management user who is present based on a checking result obtained by the presence checking unit, and transmits an approval request to the selected management user. The terminal apparatus, upon receipt of the approval request from the image forming apparatus, displays the approval request and transmits an approval result provided by the management user to the image forming apparatus.

An image forming method according to still another embodiment of the present disclosure is a method of forming an image with approval of a management user, and includes the steps of: determining, checking, selecting, transmitting, and executing. The determining step includes determining whether or not approval of the management user needs to be obtained, upon receipt of a job request from a user. The checking step includes determining whether or not a management user is present at a predetermined terminal apparatus. The selecting step includes selecting, if it is determined that the approval is necessary, the management user who is present based on a checking result of the checking of presence. The transmitting step includes transmitting an approval request to the selected management user. The executing step includes executing a job based on the job request after receiving the approval of the management user.

Additional features and advantages are described herein, and will be apparent from the following Detailed Description and the figures.

### BRIEF DESCRIPTION OF THE FIGURES

FIG. 1 is a block diagram of an image forming system according to an embodiment of the present disclosure;

FIG. 2 is a block diagram of a configuration of an embodiment of an image forming apparatus illustrated in FIG. 1;

FIG. 3 is a block diagram of an embodiment of a terminal apparatus illustrated in FIG. 1; and

FIG. 4 is a flowchart describing an embodiment of processing for a job request performed by the image forming apparatus illustrated in FIG. 1.

### DETAILED DESCRIPTION

Reference will now be made to various embodiments of the disclosure, one or more examples of which are illustrated in the accompanying drawings. Each example is provided by way of example, and not limitation to the present disclosure. In fact, it will be apparent to those skilled in the art that various modifications, combinations, additions, deletions and variations can be made in the present disclosure without departing from the scope or spirit of the present disclosure. For instance, features illustrated or described as part of one embodiment can be used in another embodiment to yield a still further embodiment. It is intended that the present disclosure covers such modifications, combinations, additions, deletions, applications and variations that come within the scope of the appended claims and their equivalents.

Hereinafter, embodiments of the present disclosure are described with reference to the figures.

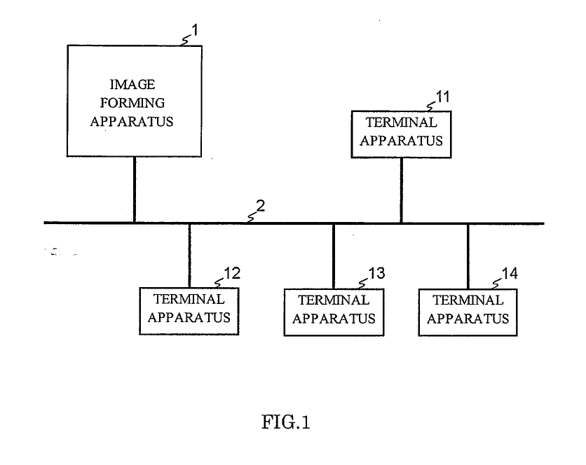

FIG. 1 is a block diagram of an image forming system according to an embodiment of the present disclosure. In the image forming system illustrated in FIG. 1, an image forming apparatus 1 is connected to a network 2. Further, a terminal apparatus 11 used by a user to issue a job request and terminal apparatuses 12 to 14 used by a plurality of management users are connected to the network 2. The management users are users who give approval in the situation where execution of a job requires approval in the image forming apparatus 1.

The image forming apparatus 1 illustrated in FIG. 1 is, for example, a printer, a copier, a fax machine, or a multifunctional peripheral. The network 2 is a computer network formed of a local area network (LAN) and/or a wide area network (WAN). The terminal apparatuses 11 to 14 are, for example, personal computers having various kinds of software installed thereon.

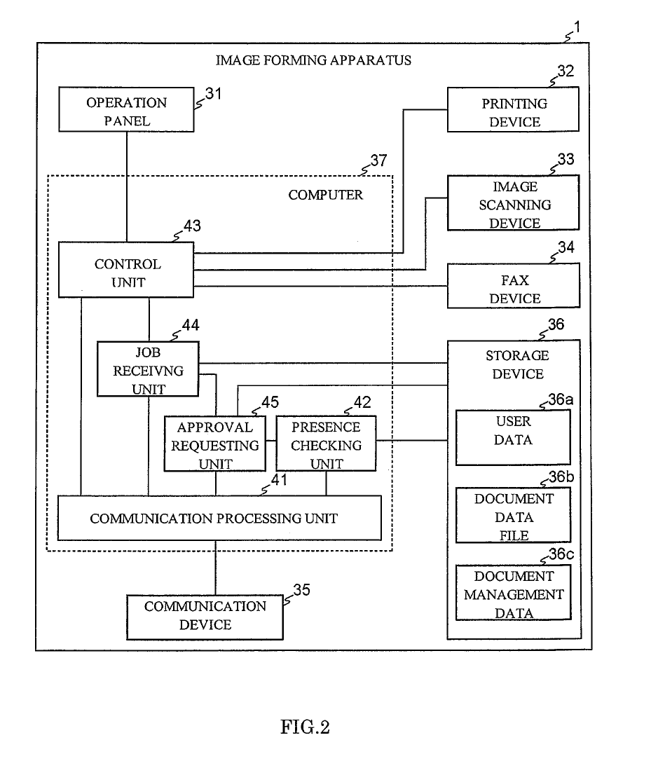

FIG. 2 is a block diagram of the configuration of the image forming apparatus 1 illustrated in FIG. 1. Referring to FIG. 2, the image forming apparatus 1 includes an operation panel 31, a printing device 32, an image scanning device 33, a fax device 34, a communication device 35, a storage device 36, and a computer 37.

The operation panel 31, which is located on the surface of the casing of the image forming apparatus 1, includes a display device for displaying various types of information for a user and an input device for detecting a user operation. An example of the display device that can be used is a liquid crystal display. Examples of the input devices include a key switch and a touch panel.

The printing device 32 is an internal device that prints an original document image based on print data. The image scanning device 33 is an internal device that optically scans an image of an original document and generates image data of the original document image. The fax device 34 is an internal device that generates a fax signal from the image data of the original document image to be transmitted and transmits the signal, and that also receives a fax signal and converts the signal into image data.

The communication device 35, which is connected to the network 2, performs data communication with other devices (for example, the terminal apparatuses 11 to 14) through the network 2 using a predetermined communication protocol. For example, a network interface or a modem is used as the communication device 35.

The storage device 36 is a non-volatile storage device such as a hard disk drive or a flash memory, and stores user data 36a, a document data file 36b, document management data 36c, and the like.

The user data 36a includes user registration information. The user registration information includes user IDs and other attribute information.

The document data file 36b includes document data such as image data generated by: scanning an image of an original document using the image scanning device 33; receiving a fax using the fax device 34; and uploaded by a management user from the terminal apparatuses 12 to 14. The storage device 36 can store one or more of the document data files 36b.

The document management data 36c includes information with respect to the correspondence between the document data file 36b and management users (user IDs of management users) who manage the document data file 36b. Note that when the document data file 36b is stored in the storage device 36, the document management data 36c associated with the document data file 36b is also stored. At this time the user who stored the document data file 36b and additional users set by the user become management users.

The computer 37 includes a central processing unit (CPU), a read only memory (ROM), and a random access memory (RAM). The computer 37 loads a program from a storage device (not illustrated), the ROM, or the like into the RAM and realizes various processing units by executing the program using the CPU.

After activation of the image forming apparatus 1, various programs are appropriately executed by the computer 37. In an embodiment, the computer 37 realizes an operating system (not illustrated) and processing units such as a communication processing unit 41, a presence checking unit 42, a control unit 43, a job receiving unit 44, and an approval requesting unit 45.

The communication processing unit 41 performs data communication using a predetermined communication protocol by controlling the communication device 35.

The presence checking unit 42 determines whether or not a management user is present at any of the terminal apparatuses 12 to 14 through communication with a presence notification unit 71 (described later). For example, when an input operation has been performed at any of the terminal apparatuses 12 to 14 by a management user, the presence checking unit 42 determines that the management user is present. In addition, the presence checking unit 42 determines that a management user is present when, for example, the management user has logged into any of the terminal apparatuses 12 to 14.

The control unit 43 is a processing unit that monitors and controls the internal devices, such as the operation panel 31, the printing device 32, the image scanning device 33, and the fax device 34.

The job receiving unit 44, upon receipt of a job request from a user, determines whether or not approval for job execution from any of one or more management users is required. When it is determined that approval is required, the job receiving unit 44 executes the job, based on the job request, after obtaining approval.

When it is determined by the job receiving unit 44 that approval is required, the approval requesting unit 45 selects a management user, who is present based on the result obtained by the presence checking unit 42, and transmits a request for approval to the selected management user.

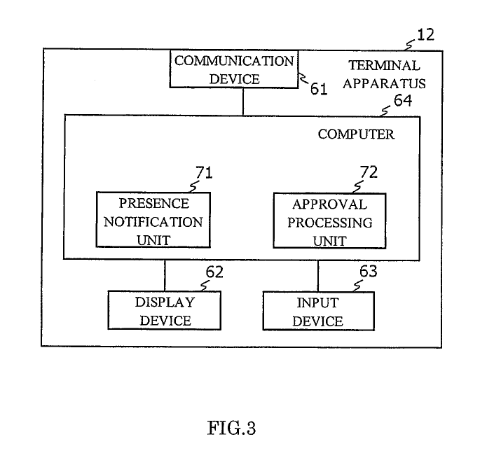

FIG. 3 is a block diagram of the terminal apparatus 12 illustrated in FIG. 1.

The terminal apparatus 12 includes a communication device 61, a display device 62, an input device 63, and a computer 64.

The communication device 61, which is connected to the network 2, performs data communication with other devices (an image forming apparatus 1, for example) through the network 2. For example, a network interface or a modem is used as the communication device 61.

The display device 62 can be, for example, a liquid crystal display which displays various screens for a user (management user) of the terminal apparatus 12. The input device 63 can be, for example, a keyboard or a mouse that detects a user operation performed by a user.

The computer 64 includes a CPU, a ROM, and a RAM. The computer 64 loads a program from a storage device (not illustrated), the ROM, or the like into the RAM and achieves various processing units by executing the program using the CPU.

After activation of the terminal apparatus 12, various programs are appropriately executed by the computer 64. In the present embodiment, the computer 64 achieves an operating system (not illustrated) and processing units such as a presence notification unit 71 and an approval processing unit 72.

The presence notification unit 71 is activated when a user (management user) logs into the terminal apparatus 12 and notifies the presence checking unit 42 in the image forming apparatus 1 that a user has logged into the terminal apparatus 12 together with the user ID. After that, the presence notification unit 71 monitors whether or not the user is using the terminal apparatus 12, and notifies the presence checking unit 42 of the user's presence in response to a request from the presence checking unit 42 of the image forming apparatus 1.

The approval processing unit 72, upon receipt of an approval request from the approval requesting unit 45 of the image forming apparatus 1, causes the display device 62 to display the approval request. Then the approval processing unit 72, when an approval or a denial operation is performed by using the input device 63, transmits the approval result to the approval requesting unit 45 of the image forming apparatus 1 in response to the approval request.

Note that the terminal apparatuses 13 and 14 have the same configuration as the terminal apparatus 12. The terminal apparatus 11 can be, for example, a personal computer having a driver installed thereon which issues a job request to the image forming apparatus 1, and has a configuration that is similar to the terminal apparatuses 12 to 14. When there is a situation wherein the terminal apparatus 11 is used by a management user, the terminal apparatus 11 is also configured similarly to the terminal apparatus 12.

An embodiment of the operations of the apparatuses in the above-described system will now be described.

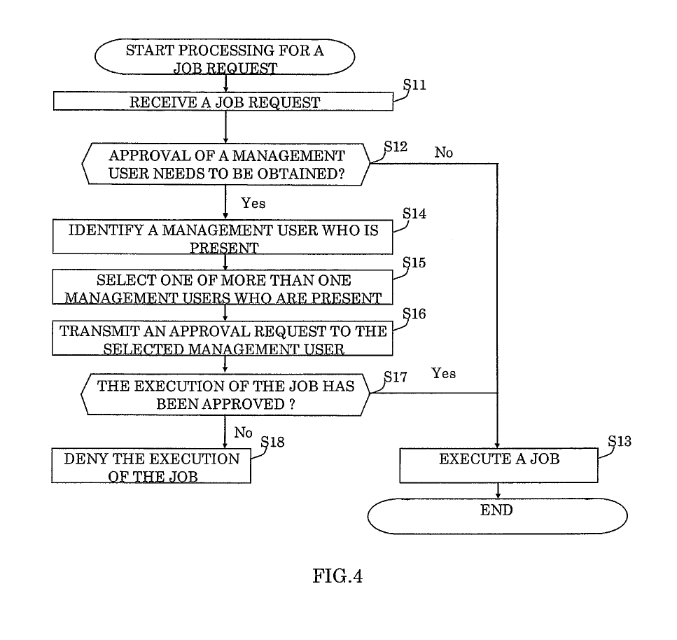

FIG. 4 is a flowchart describing an embodiment of processing for a job request performed by the image forming apparatus 1 illustrated in FIG. 1.

The job receiving unit 44 receives a job request from a user through the operation panel 31 or the terminal apparatus 11 (step S11).

The job receiving unit 44, upon receipt of the job request, determines whether or not approval of a management user is needed with respect to a requested job (step S12). At this time, the job receiving unit 44 determines whether or not approval for execution of the job is necessary based on the content (job type, image data to be printed, etc.) of the job request and/or the authority of the user.

For example, approval of a management user needs to be obtained when a user without authority to execute printing causes a print job to be executed. Similarly, approval of a management user needs to be obtained when a print job is to be executed regarding image data with a predetermined security level. In this case, information indicating the security level is embedded in the image data, and the job receiving unit 44 extracts the information from the image data.

When approval is not necessary, the job receiving unit 44 executes a job (print, copy, fax transmission, etc.) specified by the job request (step S13).

On the other hand, when it is determined that approval is necessary, the presence checking unit 42 communicates with the presence notification unit 71 of the terminal apparatus (one of the terminal apparatuses 12 to 14) of a management user who is able to approve the job request, using the communication device 35 and the communication processing unit 41, and thereby checks whether or not the management user is present. The approval requesting unit 45 identifies the management user who is present based on the results obtained by the presence checking unit 42 (step S14). When there is more than one management users present, the approval requesting unit 45 selects one of them (step S15) and transmits an approval request to the terminal apparatus (one of the terminal apparatuses 12 to 14) of the selected management user using the communication device 35 and the communication processing unit 41 (step S16).

For example, when the job receiving unit 44 receives a job (print, fax transmission, etc.) request based on the document data file 36b and determines that approval of a management user is required for the execution of the job, the approval requesting unit 45 identifies management users who manage the document data file 36b specified by the job request based on the document management data 36c, selects a management user who is present from among the identified management users, and transmits an approval request to the selected management user (i.e., a terminal apparatus being used by the management user).

This approval request includes information such as the ID and name of a user who issued the job request, a job type, and the name of the document data file.

In the terminal apparatus, the approval processing unit 72 receives this approval request using the communication device 61, and causes the display device 62 to display the information such as the ID and name of a user who issued the job request, a job type, and the name of the document data file included in the approval request, together with an approval button and a denial button, using a popup window, for example. The management user, after checking the information, presses the approval button or denial button through operation of the input device 63. The approval processing unit 72, upon detection of the operation, transmits the approval result (approval or denial), as a response to the approval request, to the approval requesting unit 45 of the image forming apparatus 1 using the communication device 61.

The approval requesting unit 45, upon receipt of the response using the communication device 35 and the communication processing unit 41, determines whether or not execution of the job has been approved or not based on the approval result included in the response (step S17).

In the situation wherein execution of a job has been approved, the job receiving unit 44 executes a job (print, copy, fax transmission, etc.) specified by the job request (step S13).

On the other hand, in the situation where execution of a job has not been approved, the job receiving unit 44 denies execution of the job and cancels the job request (step S18).

Thus, according to the embodiments described above, the presence checking unit 42 checks whether or not a management user is present at the terminal apparatuses 12 to 14. The job receiving unit 44, upon receipt of a job request from a user, determines whether or not approval for job execution is to be obtained from one of a plurality of management users. When approval is necessary, the job receiving unit 44 executes a job based on the job request after obtaining approval. When it is determined by the job receiving unit 44 that approval is necessary, the approval requesting unit 45 selects a management user who is present at the terminal apparatuses 12 to 14 based on the checking result obtained by the presence checking unit 42, and transmits an approval request to the selected management user.

This causes the approval request to be transmitted to a management user who is present, among a plurality of management users, allowing approval for job execution to be immediately obtained from the management user.

The embodiment described above is an example of the present disclosure. The present invention is not limited to this and various changes and modifications are possible within the scope of the present invention.

For example, in the embodiment described above, the presence notification unit 71 may determine that a management user is not present when predetermined processing such as display of a screen saver is being performed in the terminal apparatuses 12 to 14 (that is, when it is determined that an operation by a management user has not been performed for a predetermined period of time in the terminal apparatuses 12 to 14).

The number of the terminal apparatuses 12 to 14 for management users, which is three in the embodiment described above, is not limited to three. Further, the number of management users may be any number, so long as it is two or more. In addition, by registering a plurality of management users who may provide approval to a given user in the user data 36a, a management user who is present may be selected for a user who issued a job request from among the plurality of users registered in the user data 36a.

In the embodiment described above, the terminal apparatuses used by the management user may be fixed or management users may be allowed to use any of a predetermined plurality of terminal apparatuses. In the latter case, the presence checking unit 42 of the image forming apparatus 1 identifies the terminal apparatuses being used by management users who can give approval based on notification by the presence notification unit 71 at login time.

Further, in the embodiment described above, although the presence checking unit 42 checks management user presence when a job request which requires approval has been received, the state of management user presence may instead be periodically checked. In this situation, a management user who is present can be immediately identified without checking presence when a job request which requires approval has been received.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image forming apparatus that forms an image with approval of a management user, the apparatus comprising:
a presence checking unit that determines whether or not the management user is present at a predetermined terminal apparatus;
a job receiving unit that, upon receipt of a job request from a user, determines whether or not approval of the management user for job execution needs to be obtained and, if it is determined that approval needs to be obtained, executes a job based on the job request after obtaining the approval; and
an approval requesting unit that, if it is determined by the job receiving unit that the approval needs to be obtained, selects the management user who is present based on a checking result obtained by the presence checking unit, and transmits an approval request to the selected management user.

2. The image forming apparatus according to claim 1, comprising:
a storage device that stores a document data file and, in association therewith, document management data that indicates management users who manage the document data file;
wherein the job receiving unit receives the job request based on the document data file; and
wherein the approval requesting unit identifies, based on the document management data, the management users who manage the document data file specified by the job request, selects the management user who is present from among the identified management users, and transmits the approval request to the selected management user.

3. The image forming apparatus according to claim 1, wherein the job receiving unit determines whether or not the approval for job execution is necessary based on a content of the job request and/or an authority of the user.

4. The image forming apparatus according to claim 1, wherein the presence checking unit determines that the management user is present when an operation has been performed by the management user during a predetermined period of time.

5. The image forming apparatus according to claim 4, wherein the presence checking unit determines that the management user is not present when predetermined processing is being performed in the terminal apparatus.

6. The image forming apparatus according to claim 1, wherein the presence checking unit determines that the management user is present when the management user has logged into the terminal apparatus.

7. An image forming system that forms an image with approval of a management user, the system comprising:
an image forming apparatus; and
a plurality of terminal apparatuses used by a predetermined plurality of management users,
wherein the image forming apparatus includes:
a presence checking unit that determines whether or not the plurality of management users are present at the terminal apparatuses;
a job receiving unit that, upon receipt of a job request from a user, determines whether or not approval of one of the plurality of the management users needs to be obtained for job execution and, if it is determined that approval needs to be obtained, executes a job based on the job request after obtaining the approval; and
an approval requesting unit that, if it is determined by the job receiving unit that approval needs to be obtained, selects the management user who is present based on a checking result obtained by the presence checking unit, and transmits an approval request to the selected management user, and
wherein the terminal apparatus, upon receipt of the approval request from the image forming apparatus, displays the approval request and transmits an approval result provided by the management user to the image forming apparatus.

8. The image forming system according to claim 7, wherein the image forming apparatus includes:
a storage device that stores a document data file and, in association therewith, document management data that indicates management users who manage the document data file;
wherein the job receiving unit receives the job request based on the document data file; and
wherein the approval requesting unit identifies, based on the document management data, the management users who manage the document data file specified by the job request, selects the management user who is present from among the identified management users, and transmits the approval request to the selected management user.

9. The image forming system according to claim 7, wherein the job receiving unit determines whether or not the approval for job execution needs to be obtained based on a content of the job request and/or an authority of the user.

10. The image forming system according to claim 7, wherein the presence checking unit determines that the management user is present when an operation has been performed by the management user during a predetermined period of time.

11. The image forming system according to claim 10, wherein the presence checking unit determines that the management user is not present when predetermined processing is being performed in the terminal apparatus.

12. The image forming system according to claim 7, wherein the presence checking unit determines that the management user is present when the management user has logged into the terminal apparatus.

13. A method of forming an image with approval of a management user comprising:
determining whether or not approval of the management user needs to be obtained, upon receipt of a job request from a user;
checking whether or not the management user is present at a predetermined terminal apparatus;
selecting, if it is determined that approval is necessary, the management user who is present based on a checking result of the checking of presence, and transmitting an approval request to the selected management user; and
executing a job based on the job request after receiving the approval of the management user.

14. The method according to claim 13, comprising:
storing a document data file and, in association therewith, document management data that indicates management users who manage the document data file,
wherein the determining includes determining, upon receipt from the user of a job request based on the document data file, whether or not the approval of the management user for job execution is necessary;
wherein the selecting includes identifying the management users who manage the document data file specified by the job request based on the document management data and selecting the management user who is present from among the identified management users, and
wherein the transmitting includes transmitting the approval request to the selected management user.

15. The image forming method according to claim 14, wherein the determining includes determining, upon receipt from the user of the job request based on the document data file, whether or not approval for job execution needs to be obtained from the management user based on a content of the job request and/or an authority of the user.

16. The image forming method according to claim 13, wherein the checking includes determining that the management user is present when an operation has been performed by the management user during a predetermined period of time.

17. The image forming method according to claim 16, wherein the checking includes determining that the management user is not present when predetermined processing is being performed in the terminal apparatus.

18. The image forming method according to claim 13, wherein the checking includes determining that the management user is present when the management user has logged into the terminal apparatus.
